(19) United States
(12) Patent Application Publication
(10) Pub. No.: US 2013/0258474 A1
(43) Pub. Date: Oct. 3, 2013

(54) OPTOELECTRONIC DEVICE WITH IMPROVED LENS CAP

(71) Applicants: Cheng-Ta Chen, Taichung City (TW); Yi-Ming Chen, Zhubei City (TW); Chia-Hisen Liang, New Taipei City (TW); Jia-Lin Lin, New Taipei City (TW)

(72) Inventors: Cheng-Ta Chen, Taichung City (TW); Yi-Ming Chen, Zhubei City (TW); Chia-Hisen Liang, New Taipei City (TW); Jia-Lin Lin, New Taipei City (TW)

(21) Appl. No.: 13/438,686

(22) Filed: Apr. 3, 2012

(51) Int. Cl. G02B 23/16

(52) U.S. Cl. 359/511

(57) ABSTRACT

An optoelectronic device includes a base part and a lens cap. The base part has an optoelectronic chip mounted thereon. The lens cap is mounted over the optoelectronic chip and includes a metallic hollow cylindrical part and a plastic inner cylindrical part. The hollow cylindrical part has an opening on a top thereof. The inner cylindrical part is firmly coupled within the hollow cylindrical part, and the inner cylindrical part has a lens part located within the opening and at least three aligning members in contact with an upper circumference of the base part so as to align the lens part with the optoelectronic chip.

### BACKGROUND

1. Field of Invention

The present invention relates to a lens cap. More particularly, the present invention relates to a lens cap for an optoelectronic device.

2. Description of Related Art

An optoelectronic components, such as an optical coupling device, generally requires a lens cap to protect itself from being damaged and from EMI (Electro Magnetic Interference). Without such a protection, damage may be caused due to exposure to moisture, dirt, heat, radiation, or other hazards. Some optical coupling devices require their lens caps precisely aligned with their optoelectronic chips so as to perform their intended purposes. As disclosed in US 2006/0187454, a pre-alignment step using light beams is performed before mounting a lens cap over an optoelectronic chip to ensure that the lens cap is in a correct position. However, the pre-alignment step prolongs the manufacturing time of the whole optoelectronic component, thereby increasing its manufacturing cost.

Therefore, an improved lens cap for an optoelectronic device that overcomes the above-mentioned disadvantages is desired.

### SUMMARY

It is therefore an objective of the present invention to provide a lens cap improved design for an optoelectronic device.

In accordance with the foregoing and other objectives of the present invention, an optoelectronic device includes a base part and a lens cap. The base part has an optoelectronic chip mounted thereon. The lens cap is mounted over the optoelectronic chip and includes a metallic hollow cylindrical part and a plastic inner cylindrical part. The hollow cylindrical part has an opening on a top thereof. The inner cylindrical part is firmly coupled within the hollow cylindrical part, and the inner cylindrical part has a lens part located within the opening and at least three aligning members in contact with an upper circumference of the base part so as to align the lens part with the optoelectronic chip.

In an embodiment disclosed herein, the at least three aligning members are located at a lower circumference of the inner cylindrical part.

In an embodiment disclosed herein, a lower circumference of the hollow cylindrical part is soldered to the base part.

In an embodiment disclosed herein, the lens part includes a ball lens, an aspherical lens, a convex lens or a concave lens.

In an embodiment disclosed herein, the inner cylindrical part includes an upper O-shaped part surrounding the lens part, and the opening of the hollow cylindrical part and the upper O-shaped part of the inner cylindrical part collectively define an O-shaped groove therebetween.

In an embodiment disclosed herein, an adhesive seal is airtight filled within the O-shaped groove.

In an embodiment disclosed herein, an optical filter is attached to the upper O-shaped part and is aligned with the lens part.

In an embodiment disclosed herein, the inner cylindrical part includes a lower O-shaped part surrounding the lens part.

In an embodiment disclosed herein, an optical filter is attached to the lower O-shaped part and is aligned with the lens part.

In an embodiment disclosed herein, the inner cylindrical part has a refractive index ranging from about 1.35 to about 1.7.

Thus, the lens cap of the optoelectronic device consists of a hollow cylindrical part and an inner cylindrical part. As long as a lens part of the inner cylindrical part can be well-manufactured and properly positioned on the base part of the optoelectronic device by means of its aligning members, the hollow cylindrical part is not required to be precisely manufactured, thereby reducing the manufacturing cost of the hollow cylindrical part and the lens cap. With the lens cap being properly aligned with the optoelectronic chip by means of its aligning members, the pre-alignment step using light beams (as described in the “Description of Related Art”) can be omitted to save the manufacturing cost.

It is to be understood that both the foregoing general description and the is following detailed description are by examples, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 illustrates a cross-sectional view of an optoelectronic device according to one preferred embodiment of this invention;

FIG. 2 illustrates a cross-sectional view of an optoelectronic device according to another preferred embodiment of this invention;

FIG. 3 illustrates a cross-sectional view of an optoelectronic device according to still another preferred embodiment of this invention;

FIG. 4 illustrates a cross-sectional view of an optoelectronic device according to yet another preferred embodiment of this invention;

FIG. 5 illustrates a perspective view of the lens cap of the optoelectronic device in FIG. 1;

FIG. 6 illustrates another perspective view of the lens cap of the optoelectronic device in FIG. 1; and

FIG. 7 illustrates a cross-sectional view of an optoelectronic device according to yet another preferred embodiment of this invention.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

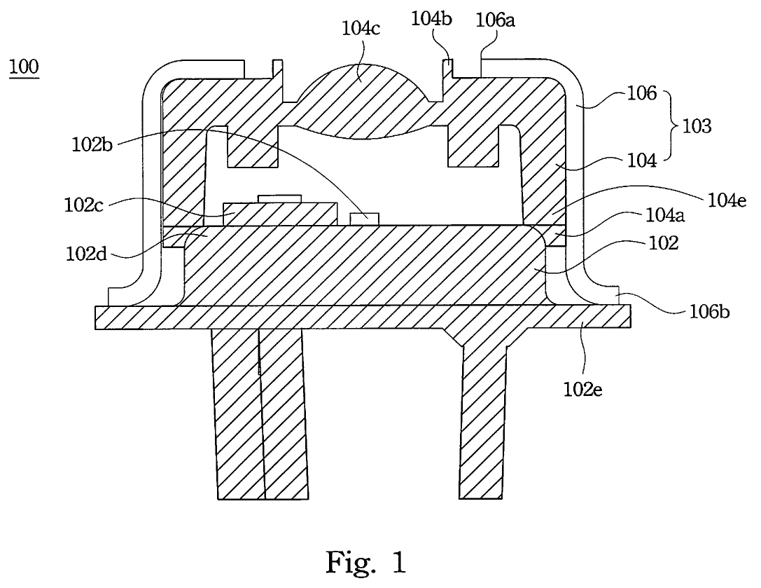

FIG. 1 illustrates a cross-sectional view of an optoelectronic device 100 according to one preferred embodiment of this invention. The optoelectronic device 100 basically includes a base part 102 (also referred as a “header”) and a lens cap 103. The base part 102 includes an optoelectronic chip 102b thereon. The optoelectronic chip 102b can be a light emitting diode or other types of optoelectronic components. The assistant chip 102c can be a driver IC or other integrated circuits for the optoelectronic chip 102b. The lens cap 103 is mounted over the optoelectronic chip 102b and is secured to the base part 102. The lens cap 103 is used to protect the optoelectronic chip 102b from being damaged and from EMI (Electro Magnetic Interference) as well as to provide optical functions for the optoelectronic chip 102b. In this embodiment, the lens cap 103 consists of a hollow cylindrical part 106 and an inner cylindrical part 104. The hollow cylindrical part 106 can be made from a metallic material and is grounded to the base part 102 so as to protect the optoelectronic chip 102b from EMI effects. The inner cylindrical part 104 can be made from a transparent plastic material of a refractive index ranging from about 1.35 to about 1.7 by injection molding. The inner cylindrical part 104 is firmly coupled within the hollow cylindrical part 106 such that the lens cap 103 can protect the optoelectronic chip 102b from being exposed to water or moisture. In this embodiment, the lens part 104c can be a ball lens, an aspherical lens, a convex lens or a concave lens.

The hollow cylindrical part 106 has an opening 106a on its top to expose a lens part 104c of the inner cylindrical part 104. In order to properly position the lens part 104c, i.e., to align the lens part 104c with the optoelectronic chip 102b, at least three aligning members 104a of the inner cylindrical part 104 are designed to be in contact with an upper circumference 102d of the base part 102. When the aligning members 104a of the inner cylindrical part 104 are in contact with an upper circumference 102d of the base part 102, the lens part 104c is properly aligned with the optoelectronic chip 102b such that the intended optical functions of the lens part 104c can be performed. A lower circumference 106b of the hollow cylindrical part 106 is fastened to a lower circumference 102e of the base part 102 by soldering or plastic welding after the lens part 104c is properly aligned with the optoelectronic chip 102b.

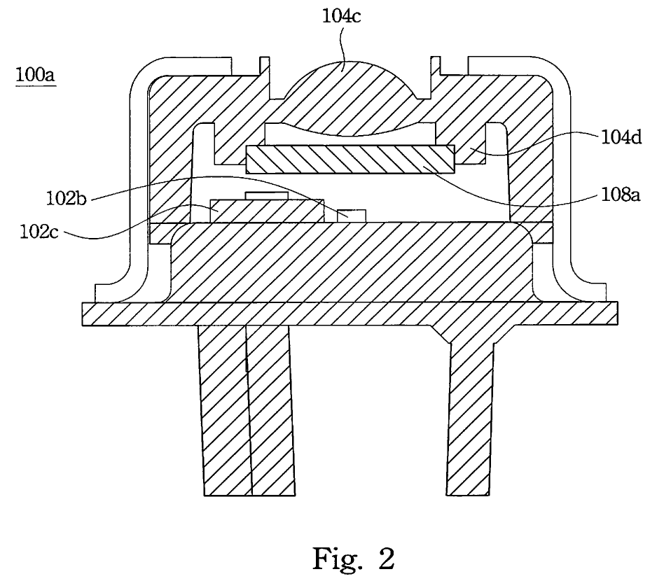

FIG. 2 illustrates a cross-sectional view of an optoelectronic device 100a according to another preferred embodiment of this invention. The optoelectronic device 100a is different from the optoelectronic device 100 in that an optical filter 108a is attached to a lower O-shaped part 104d of the inner cylindrical part 104. The optical filter 108a is added to provide an additional optical function for the optoelectronic chip 102b. The optical filter 108a should be aligned with the lens part 104c as well as the optoelectronic chip 102b to achieve its intended purpose.

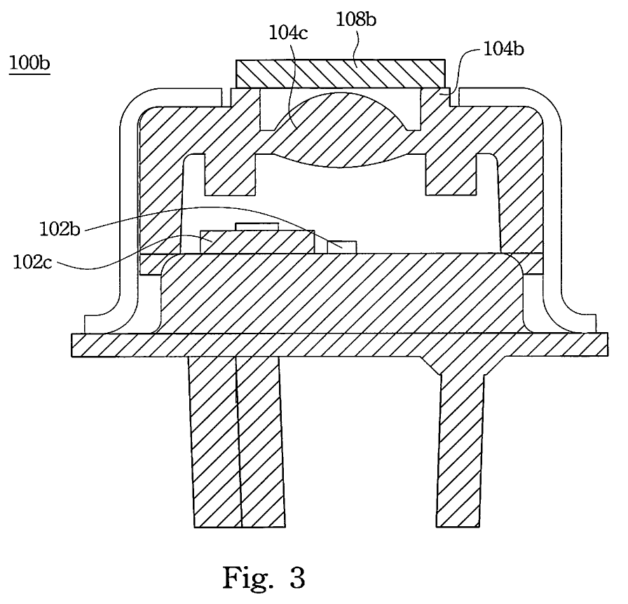

FIG. 3 illustrates a cross-sectional view of an optoelectronic device 100b according to still another preferred embodiment of this invention. The optoelectronic device 100b is different from the optoelectronic device 100 in that an optical filter 108b is attached to an upper O-shaped part 104b of the inner cylindrical part 104. The optical filter 108b is added to provide an additional optical function for the optoelectronic chip 102b. The optical filter 108b should be aligned with the lens part 104c as well as the optoelectronic chip 102b to achieve its intended purpose.

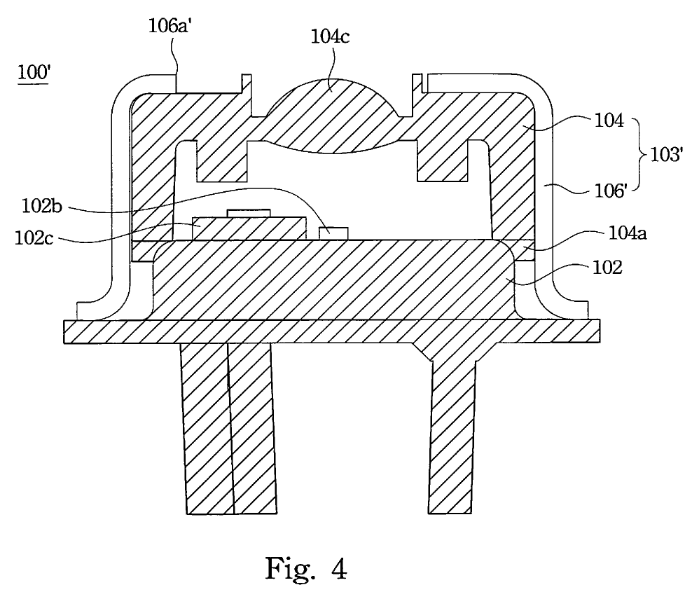

FIG. 4 illustrates a cross-sectional view of an optoelectronic device 100′ according to yet another preferred embodiment of this invention. The lens cap 103′ still performs its intended function with its the hollow cylindrical part 106′ not well manufactured. In this case, the inner cylindrical part 104 is well manufactured, but the hollow cylindrical part 106′ not well manufactured. In particular, an opening 106a′ of the hollow cylindrical part 106′ is non-central relative to the lens part 104c. As long as the opening 106a′ of the hollow cylindrical part 106′ can expose the lens part 104c and the lens part 104c is properly aligned with the optoelectronic chip 102b, the lens cap 103 still performs its intended function. Since the inner cylindrical part 104 is preferably made from a transparent plastic material by injection molding, it is easier to control its size and dimension such that the lens part 104c and the aligning members 104a can be well manufactured. Compared with the inner cylindrical part 104, it is harder or more costly to control the size and dimension of the metallic hollow cylindrical part 106 in its manufacturing process. Therefore, the manufacturing cost of lens cap 103 can be saved without abandoning some improperly-manufactured hollow cylindrical parts, e.g. the hollow cylindrical parts 106′ as illustrated in FIG. 4.

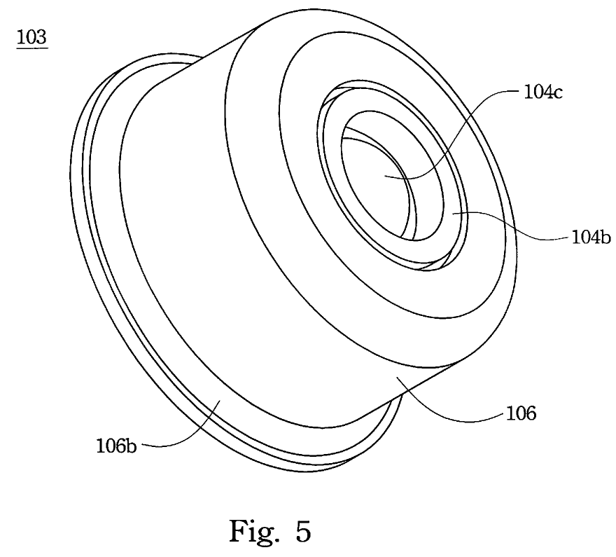

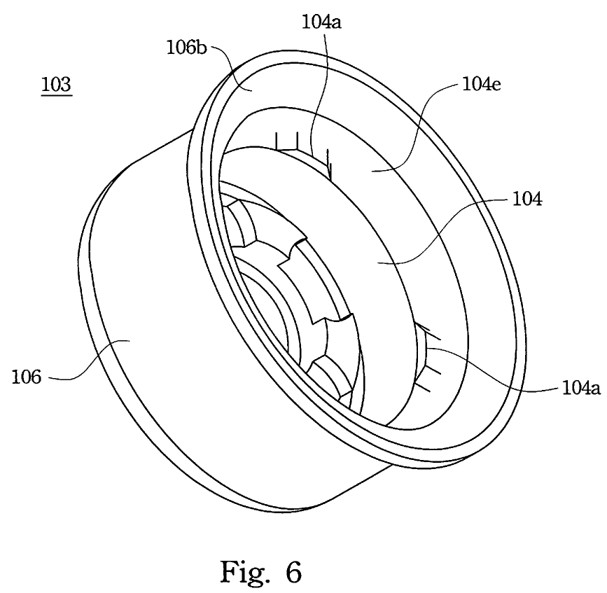

FIG. 5 illustrates a perspective view of the lens cap of the optoelectronic device in FIG. 1, and FIG. 6 illustrates another perspective view of the lens cap of the optoelectronic device in FIG. 1. In this embodiment, the lens cap 103 is basically circular, but not limited thereto. The aligning members 104a can be any structures, which can easily hold the upper circumference 102d of the base part 102 and properly align the lens part 104c with the optoelectronic chip 102b on the base part 102. The aligning members 104a can be designed at, but not limited to, the lower circumference 104e of the inner cylindrical part 104.

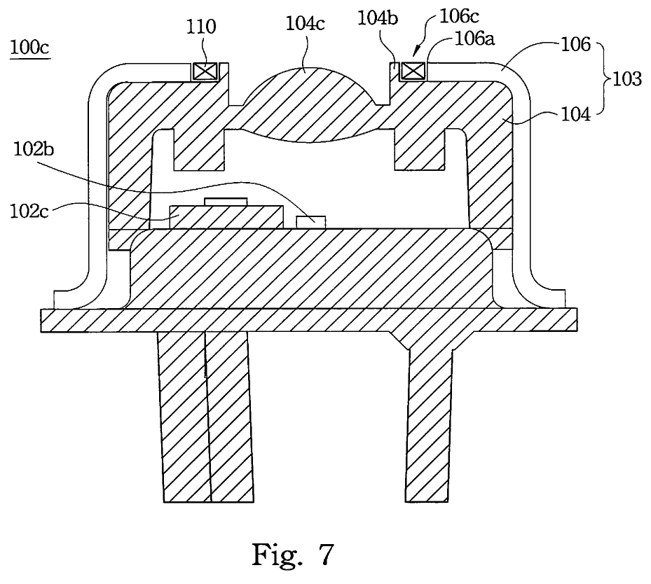

FIG. 7 illustrates a cross-sectional view of an optoelectronic device 100c according to yet another preferred embodiment of this invention. In order to further enhance a protection reliability of the lens cap 103, an adhesive seal 110 can be airtight filled into an O-shaped groove 106c defined between the opening 106a of the hollow cylindrical part 106 and the upper O-shaped part 104b of the inner cylindrical part 104 such that the inner cylindrical part 104 is airtight coupled within the hollow cylindrical part. The adhesive seal 110 enhance the protection reliability of the lens cap 103 from water, moisture or other hazards.

According to the above-discussed embodiments, the lens cap of the optoelectronic device consists of a hollow cylindrical part and an inner cylindrical part. As long as a lens part of the inner cylindrical part can be well-manufactured and properly positioned on the base part of the optoelectronic device by means of its aligning members, the hollow cylindrical part is not required precisely manufactured, thereby reducing the manufacturing cost of the hollow cylindrical part and the lens cap. With the lens cap being properly aligned with the optoelectronic chip by means of its aligning members, the pre-alignment step using light beams (as described in the “Description of Related Art”) can be omitted to save manufacturing cost.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. An optoelectronic device comprising:
a base part comprising an optoelectronic chip mounted thereon;
a lens cap mounted over the optoelectronic chip, the lens cap comprising:
a metallic hollow cylindrical part defining an opening on a top thereof; and
a plastic inner cylindrical part firmly coupled within the hollow cylindrical part, the inner cylindrical part having an lens part disposed within the opening and at least three aligning members disposed in contact with an upper circumference of to the base part so as to align the lens part with the optoelectronic chip.

2. The optoelectronic device of claim 1, wherein the at least three aligning members are disposed at a lower circumference of the inner cylindrical part.

3. The optoelectronic device of claim 1, wherein a lower circumference of the hollow cylindrical part is fastened to the base part by soldering or plastic welding.

4. The optoelectronic device of claim 1, wherein the lens part comprises a ball lens, an aspherical lens, a convex lens or a concave lens.

5. The optoelectronic device of claim 1, wherein the inner cylindrical part comprises an upper O-shaped part surrounding the lens part, and the opening and the upper O-shaped part collectively define an O-shaped groove therebetween.

6. The optoelectronic device of claim 5, further comprising an adhesive seal to be airtight filled within the O-shaped groove.

7. The optoelectronic device of claim 5, further comprising an optical filter attached to the upper O-shaped part and aligned with the lens part.

8. The optoelectronic device of claim 1, wherein the inner cylindrical part comprises a lower O-shaped part surrounding the lens part.

9. The optoelectronic device of claim 8, further comprising an optical filter attached to the lower O-shaped part and aligned with the lens part.

10. The optoelectronic device of claim 1, wherein the plastic inner cylindrical part has a refractive index substantially ranging from about 1.35 to about 1.7.
